(19) United States
(12) Patent Application Publication
(10) Pub. No.: US 2025/0224715 A1
(43) Pub. Date: Jul. 10, 2025

(54) ELECTRONIC DEVICE AND OPERATION METHOD THEREOF

(71) Applicant: Samsung Electronics Co., Ltd., Suwon-si (KR)

(72) Inventors: Minseok KIM, Suwon-si (KR); Yunsoo KIM, Suwon-si (KR); Sangbeom PARK, Suwon-si (KR); Junhyeok PARK, Suwon-si (KR); Yoonsang LEE, Suwon-si (KR); Ahryeon CHOI, Suwon-si (KR); Sangmin HWANG, Suwon-si (KR); Gilhwan KIM, Suwon-si (KR); Yohwan JOO, Suwon-si (KR)

(73) Assignee: Samsung Electronics Co., Ltd., Suwon-si (KR)

(21) Appl. No.: 18/754,970

(22) Filed: Jun. 26, 2024

(30) Foreign Application Priority Data
Jan. 4, 2024 (KR) 10-2024-0001688

(51) Int. Cl. G05B 19/418; G03F 7/00

(52) U.S. Cl. CPC G05B 19/41875; G03F 7/70633; G05B 2219/45031

(57) ABSTRACT

An electronic device including a communication circuit, at least one processor, and at least one memory configured to store instructions, the at least one memory and instructions configured to, with the at least one processor, cause the electronic device to: receive equipment data of a semiconductor exposure equipment from an external database through the communication circuit, generate integrated data that integrates the equipment data by wafer and equipment model, generate a model that predicts daily wafer production of the semiconductor exposure equipment based on process time of the semiconductor exposure equipment for a wafer using the integrated data, the process time including wafer swap time for each equipment, lot swap time for each equipment, and exposure time for each equipment, and evaluate performance of the semiconductor exposure equipment based on the generated model.

### CROSS-REFERENCE TO RELATED APPLICATION

This application claims priority to and the benefit of, under 35 U.S.C. § 119, Korean Patent Application No. 10-2024-0001688 filed in the Korean Intellectual Property Office on Jan. 4, 2024, the entire contents of which are incorporated herein by reference.

### BACKGROUND

The present inventive concepts relate to electronic devices and operation methods of the electronic devices.

Recently, as extra ultraviolet (EUV) exposure technology has been developed as one of the semiconductor exposure technologies, the introduction of EUV exposure equipment is increasing. EUV exposure technology refers to technology that uses a light source of extreme ultraviolet ray wavelength in an exposure process.

With EUV exposure equipment, new process items are added compared to deep ultraviolet (DUV) exposure equipment, and verification of equipment parameters may be difficult, so there may be difficulties in operating EUV exposure equipment and improving productivity.

### SUMMARY

Example embodiments of the present inventive concepts provide electronic devices and operation methods of the electronic devices that automate the process of evaluating the performance of semiconductor exposure equipment based on process time, analyzing the cause of loss, and deriving or generating an equipment solution.

An electronic device according to some example embodiments includes a communication circuit, at least one processor, and at least one memory configured to store instructions, the at least one memory and instructions configured to, with the at least one processor, cause the electronic device to: receive equipment data of a semiconductor exposure equipment from an external database through the communication circuit, generate integrated data that integrates the equipment data by wafer and equipment model, generate a model that predicts daily wafer production of the semiconductor exposure equipment based on process time of the semiconductor exposure equipment for a wafer using the integrated data, the process time including wafer swap time for each equipment, lot swap time for each equipment, and exposure time for each equipment, and evaluate performance of the semiconductor exposure equipment based on the generated model.

An electronic device according to some example embodiments includes a communication circuit, at least one processor, and at least one memory configured to store instructions, the at least one memory and instructions configured to, with the at least one processor, cause the electronic device to: receive equipment data of a semiconductor exposure equipment from an external database through the communication circuit, generate integrated data that integrates the equipment data by wafer and equipment model, preprocess the integrated data to obtain wafer data, lot data, and parameter data, calculate wafer swap time for each equipment, lot swap time for each equipment, and exposure time for each equipment based on the wafer data, the lot data, and the parameter data, generate a production prediction model that predicts daily wafer production based on the wafer swap time for each equipment, the lot swap time for each equipment, and the exposure time for each equipment, and evaluate performance of the semiconductor exposure equipment based on the production prediction model.

An operation method of an electronic device according to some example embodiments includes receiving equipment data of a semiconductor exposure equipment from an external database through a communication circuit of the electronic device, generating integrated data that integrates the equipment data by wafer and equipment model, generating a model that predicts daily wafer production of the semiconductor exposure equipment based on process time of the semiconductor exposure equipment for the wafer using the integrated data, and evaluating performance of the semiconductor exposure equipment based on the generated model.

According to some example embodiments, it may be possible to evaluate the performance of a semiconductor exposure equipment based on process time, automate the process of analyzing the cause of loss and deriving equipment solutions, and improve the productivity of the semiconductor exposure equipment.

### BRIEF DESCRIPTION OF THE DRAWINGS

FIG. 1 is a block diagram of an electronic device according to some example embodiments.

FIG. 2 is a flowchart showing an operation method of an electronic device according to some example embodiments.

FIGS. 3 to 7 are drawings for illustrating operations of an electronic device according to some example embodiments.

FIGS. 8 and 9 are diagrams illustrating examples of visualization information provided by an electronic device according to some example embodiments.

FIG. 10 is a diagram illustrating an example of a computer device implementing an electronic device according to some example embodiments.

### DETAILED DESCRIPTION

Hereinafter, the present inventive concepts will be described in detail with reference to the accompanying drawings, in which some example embodiments of the present inventive concepts are shown. As those skilled in the art would realize, the described example embodiments may be modified in various different ways, all without departing from the spirit or scope of the present inventive concepts.

The drawings and description are to be regarded as illustrative in nature and not restrictive. Like reference numerals in different drawings designate like elements throughout the specification.

Size and thickness of each constituent element in the drawings are arbitrarily illustrated for better understanding and ease of description, and the following example embodiments are not limited thereto. In the drawings, the thickness of layers, films, panels, regions, etc., are exaggerated for clarity. In the drawings, the thickness of some layers and regions may be exaggerated for ease of description.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

In addition, unless explicitly described to the contrary, the word “comprise”, and variations such as “comprises” or “comprising”, will be understood to imply the inclusion of stated elements but not the exclusion of any other elements.

In addition, the phrase “on a plane” means a view from a position above the object (e.g., from the top), and the phrase “on a cross-section” means a view of a cross-section of the object which is vertically cut from the side.

In the various example embodiments disclosed herein, a term “ . . . module” or “ . . . unit” may refer, for example, to an element that performs one or more functions or operations. The “module” or “unit” may be realized as hardware, software, or any combinations thereof. A plurality of “ . . . modules” or “ . . . units” may be integrated into at least one module and realized as at least one processor, except for a case where the respective “ . . . modules” or “ . . . units” need to be realized as discrete specific hardware.

In this specification, “transmission” or “provision” may include indirect transmission or provision via another device or by use of a bypass in addition to direct transmission or provision.

In this specification, an expression recited in the singular may be construed as singular or plural unless the expression “one”, “single”, etc. is used.

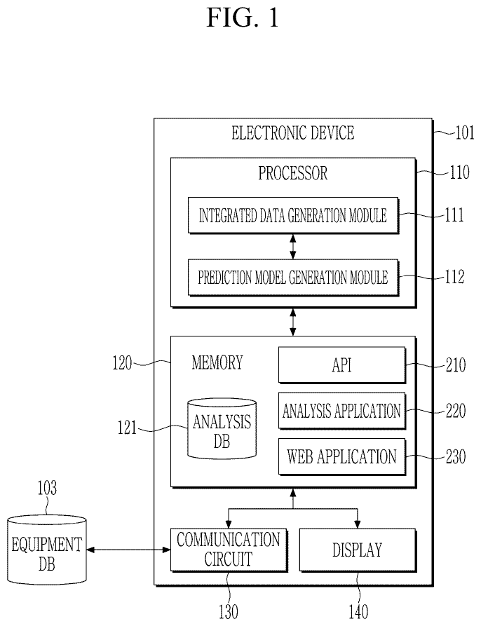

Hereinafter, with reference to FIG. 1, an electronic device according some example embodiments will be described.

FIG. 1 is a block diagram of an electronic device according to some example embodiments.

Referring to FIG. 1, an electronic device 101 according to some example embodiments may include at least one processor 110, a memory 120, a communication circuit 130, and a display 140. In some example embodiments, the electronic device 101 may omit at least one of the above-described components (e.g., the display 140) or may, in some example embodiments, include another component (e.g., an input device).

The at least one processor 110 may be operatively connected to the memory 120, the communication circuit 130, and the display 140. The processor 110 may control the operation of the electronic device 101 by controlling at least one other component of the electronic device 101 connected to the processor 110.

The processor 110 may execute instructions stored in the memory 120. The processor 110 may execute applications (e.g., analysis application 220 and web application 230) stored in memory 120. Each application may be a set of instructions. The processor 110 may enable the electronic device 101 to perform operations described later by executing instructions stored in the memory 120. The operations described as being performed by the processor 110 below may be performed by the processor 110 and/or at least one other component of the electronic device 101 connected to the processor 110, so it can be understood as being performed by the electronic device 101.

The processor 110 may receive equipment data of a semiconductor exposure equipment from an external database (e.g., equipment database (equipment DB) 103) through the communication circuit 130. The equipment database 103 may normalize log data of semiconductor exposure equipment according to the characteristics of each data and store the log data in a table format.

The semiconductor exposure equipment may be, for example, an extreme ultraviolet (EUV) equipment that performs (or is configured to perform) an exposure process using a light source with an extreme ultraviolet wavelength. The exposure process by the EUV equipment includes an exposure process for each wafer, a chuck swap process between a wafer and a subsequent wafer, and a reticle align process, and may further include a reticle swap process between the last wafer in the lot and the first wafer in the subsequent wafer, in addition to the chuck swap process and the reticle align process. For example, one lot may include 24 wafers. Hereinafter, the time required for the exposure process for each wafer may be referred to as wafer exposure time (WET). The time required between exposure of a wafer from the same lot and a subsequent wafer may be referred to as wafer swap time (WST). The time required between exposure of a different lot of wafers and subsequent wafers may be referred to as lot overhead time or a lot swap time (LOH).

Equipment data stored in the equipment database 103 may include, for example, track process history, equipment operation history, wafer production history, lot production history, layout history, wafer reject history, performance history, equipment error history, equipment event history, and/or equipment sensor history, but example embodiments are not limited thereto.

The track process history may include the history of track signals that occur when a wafer moves between a spinner that performs processes other than exposure, such as photoresist application and development, and a scanner that performs the exposure process. For example, delays in track signals may affect process times. Equipment operation history may include history of the planned operation time of equipment, actual operation time, wafer input quantity, wafer rework quantity, and wafer shipment (out) quantity. Equipment operation history may be stored in shift units (e.g., 8 hours or 8 hour units/intervals of time). The lot production history may refer to the production history of the lot unit of the equipment, and the wafer production history may refer to the production history of the wafer unit of the equipment. The lot production history may include history such as lot ID, recipe ID, lot input time, number of wafers produced in the lot, and number of wafers rejected in the lot, but example embodiments are not limited thereto. Wafer production history may include wafer ID, recipe ID, wafer input time, rejection status, etc. Layout history may refer to the history of the layout of products produced by equipment. The layout history may include, for example, information such as the shot count, the size of the shot in the x-direction (shot x size), and the size of the shot in the y-direction (shot y size). Wafer rejection history may refer to the history of wafers rejected within the operation time of the equipment. The performance history may include information about the performance of the equipment, such as slit integrated energy (SLIE), illumination data, and target dose. Equipment error history and equipment event history may refer to the history of logs generated when equipment errors and events occur, respectively. Equipment sensor history may refer to the history of logs for each sensor collected by various sensors in the equipment.

The processor 110 may receive equipment data stored in the equipment database 103 and the processor 110 may store the equipment data in the memory 120. For example, the processor 110 may denormalize and store the received equipment data. In some example embodiments, when the processor 110 denormalizes equipment data, denormalization may mean normalizing each table and integrating data distributed in each table.

According to some example embodiments, the processor 110 may include an integrated data generation module 111 and a prediction model generation module 112. The integrated data generation module 111 and the prediction model generation module 112 may represent functions executed by the processor 110. The operations of the integrated data generation module 111 and the operations of the prediction model generation module 112, according to some example embodiments, may be operations performed by the electronic device 101 by executing instructions stored in the memory 120 by the processor 110.

The integrated data generation module 111 may generate integrated data based on equipment data. The integrated data generation module 111 may generate integrated data and store it in the analysis database (analysis DB) 121 of the memory 120.

The integrated data generation module 111 may generate integrated data that integrates equipment data by wafer and equipment model. The integrated data generation module 111 may integrate process time among equipment data for each wafer and equipment model. Process time may include, for example, wafer change time, lot change time, and exposure time. The integrated data generation module 111 may integrate measurement values from equipment sensors among equipment data for each wafer and equipment model. Equipment sensors may include, for example, various sensors of EUV equipment. The integrated data generation module 111 may integrate equipment error and event information among equipment data for each wafer and equipment model. Error and event information may include the time and code information at which a predetermined error and event code of the equipment occurred. The integrated data generation module 111 may integrate equipment and product parameter values among the equipment data for each wafer and equipment model. Parameter values of equipment and products may include product specification information, process recipe information, and/or equipment setting values.

Integrated data may include process time, measurement values of equipment sensors, equipment error and event information, and parameter values of equipment and products.

The prediction model generation module 112 may use the integrated data to generate a model that predicts the daily wafer production of the semiconductor exposure equipment based on the process time of the semiconductor exposure equipment for the wafer. The prediction model generation module 112 may preprocess the integrated data. The prediction model generation module 112 may remove invalid data from the integrated data. For example, the prediction model generation module 112 may remove data about rejected wafers and/or non-pattern wafers from the integrated data. A rejected wafer may refer to a wafer that has defects during the process or has been used for test. A non-patterned wafer may refer to a wafer on which a pattern has not been formed.

The prediction model generation module 112 may obtain wafer data, lot data, and parameter data from the integrated data. In some example embodiments, the prediction model generation module 112 may obtain the wafer data, lot data, and parameter data from the integrated data generation module 111. The prediction model generation module 112 may obtain wafer data in which wafer-related data of the integrated data is sorted according to exposure time. Wafer data may be, for example, data in which wafer swap time, exposure time, and product parameter values are sorted according to exposure time. The prediction model generation module 112 may obtain lot data by sorting the data related to lot of the integrated data according to the time the wafer was input into the equipment. For example, lot data may be data on characteristics dependent on the lot, such as lot swap time, sorted according to the time the wafer was put into the equipment. The prediction model generation module 112 may obtain parameter data by arranging the parameter values of equipment and products in the integrated data and the measurement values of equipment sensors according to the sensor measurement time. The sensor measurement time may refer to the sensor log data generation time. Parameter data may be data that links parameter values of equipment and products with measurement values of equipment sensors. Measurement values from equipment sensors may, for example, include data about the source of the equipment.

The prediction model generation module 112 may use wafer data, lot data, and parameter data to generate a model that predicts the wafer production of the semiconductor exposure equipment based on the process time of the semiconductor exposure equipment. According to some example embodiments, the process time of the semiconductor exposure equipment may include wafer swap time, lot swap time, and exposure time. Hereinafter, the model for predicting the wafer production of a semiconductor exposure equipment may be referred to as a production prediction model for convenience and ease of description. The prediction model generation module 112 may generate the production prediction model based on the wafer swap time, lot swap time, and exposure time of the semiconductor exposure equipment.

Wafer swap time data and lot swap time data may be clustered by equipment model. The prediction model generation module 112 may calculate a first quartile of wafer swap time for each equipment model based on wafer data. The prediction model generation module 112 may sort the wafer swap time data for each equipment model from small to large values and then calculate a value corresponding to the top 25%. The prediction model generation module 112 may calculate the first quartile of lot swap time for each equipment model based on lot data. The prediction model generation module 112 may sort the lot swap time data for each equipment model from small to large values and then calculate a value corresponding to the top 25%.

Exposure time data may have different distributions even for the same equipment, depending on the parameter values of the equipment and product. The prediction model generation module 112 may calculate the exposure time for each equipment based on the correlation between the exposure time and parameter values of the equipment and product.

For example, exposure time may be related to shot count. A shot may be a unit of number of times an exposure process is performed. For example, when overlapping exposure occurs, the exposure process may be performed twice or may be performed four times the predetermined number of times. However, according to some example embodiments, the stored value for the shot count may not be the actual number of times the exposure process was performed, but rather the predetermined number of times. The prediction model generation module 112 may calculate the value of a variable proportional to the exposure time using the shot count value, and filter data where the ratio between the exposure time and the variable value forms an abnormal cluster. The prediction model generation module 112 may remove data where the ratio between the exposure time and the variable value forms an abnormal cluster. The prediction model generation module 112 may extract data where the ratio between the exposure time and the variable value forms a normal cluster.

A variable proportional to exposure time may be, for example, scan time. The scan time may be calculated through Equation 1 below. In Equation 1, scan speed may be the speed of scanning one die in one wafer in the longitudinal direction (e.g., y direction). Scan speed, in other words, may be the moving speed of the wafer stage. Slip (slit integrated power) production may be the power of light irradiated to one die. Slip production may be represented in units of the power of light per unit distance (W/m). The dose is the amount of light required to pattern one die, and the dose matching factor is a value that amplifies the power of light according to the amount of radiation, and may be a predetermined or alternatively, a desired constant value for each equipment. In some example embodiments, the shot count may be the number of shots printed on one wafer. Shot y size may be the size of the shot in the longitudinal direction (e.g., y direction). For example, one die may be taken per shot. For example, the shot count may correspond to the number of dies exposed on one wafer. Shot y size may be the y-direction length of the die. According to some example embodiments, a speed at which the die is scanned in the lateral direction (e.g., x-direction) may be small or very small and may be determined for each equipment model, so the speed at which the die is scanned in the lateral direction may have a minimal effect on the process time, so the speed the die is scanned in the lateral direction may not be considered in calculating the scan time in Equation 1 below.

$$scan speed = \frac{slip production}{dose * dose matching factor} \qquad ( Equation 1 )$$

$$scan time = \frac{shot count * shot y size}{scan speed}$$

The prediction model generation module 112 may perform filtering based on the value obtained by dividing the wafer exposure time (WET) by the scan time calculated through Equation 1 (R=WET/scan time). For example, the prediction model generation module 112 may calculate the R (R-WET/scan time) value for each wafer, define wafer data whose R value is greater than or equal to a specified or alternatively, desired similarity as a normal cluster, and extract data included in normal clusters by excluding data not included in normal clusters.

The prediction model generation module 112 may learn the correlation between exposure time and parameter values of equipment and products using the extracted wafer data and parameter data corresponding to the extracted wafer data. For example, the relational equation that represents the correlation between exposure time and parameter values of equipment and products may be as shown in Equation 2 below. The prediction model generation module 112 may acquire the coefficients of the relationship (e.g., a, b, c, and d in Equation 2) through learning (e.g., machine learning). The prediction model generation module 112 may calculate an exposure time wetₙ for each process recipe of each equipment based on the obtained coefficients. In Equation 2, n may be a value representing a process recipe, m may be a value representing an equipment, and wetₙ may be an exposure time for each process recipe.

$$scan {speed}_{n} = \frac{slip {production}_{n}}{{dose}_{n} \times dose matching {factor}_{m}} \qquad ( Equation 2 )$$

$${wet}_{n} = shot {count}_{n} \times ( a \frac{shot y {size}_{n}}{scan {speed}_{n}} + b \frac{scan {speed}_{n}^{2}}{10000} + c \frac{scan {speed}_{n}}{100} + d )$$

The prediction model generation module 112 may calculate the exposure time for each equipment based on the ratio between at least one process recipe processed by each equipment. For example, the prediction model generation module 112 may calculate an average wafer exposure time wet for one wafer in each equipment through Equation 3 below. In Equation 3, n is a value representing a process recipe, and rₙ may be a ratio of a specific recipe among at least one process recipe processed by each equipment. For example, if the equipment processes a wafer with a process recipe of n=1, and processes b wafers with a process recipe of n=2, r₁ may be a/(a+b), and r₂ may be b/(a+b). The prediction model generation module 112 may calculate the average wafer exposure time wet for one wafer of each equipment by adding the exposure time wetₙ for each process recipe multiplied by the ratio rₙ of each recipe.

$$wet = {r}_{1} {wet}_{1} + {r}_{2} {wet}_{2} + … + {r}_{n} {wet}_{n} \qquad ( Equation 3 )$$

The prediction model generation module 112 may calculate the exposure time for each equipment through Equations 1 to 3 described above. The prediction model generation module 112 may identify the model of each equipment, and obtain the first quartile of the wafer swap time of the identified equipment model as the wafer swap time of each equipment. The prediction model generation module 112 may identify the model of each equipment, and obtain the first quartile of the lot swap time of the identified equipment model as the lot swap time of each equipment.

The prediction model generation module 112 may generate a production prediction model based on wafer swap time for each equipment, lot swap time for each equipment, and exposure time for each equipment. For example, the production prediction model may be as shown in Equation 4 below. In Equation 4, WPD may be the daily wafer production, WET may be the wafer exposure time for each equipment, WST may be the wafer swap time for each equipment, and LOH may be the lot swap time for each equipment. The wafer swap time for each equipment WST, the lot swap time for each equipment LOH, and the wafer exposure time for each equipment WET may each be times for one wafer. The production prediction model may be the time corresponding a day divided by the sum of the wafer swap time for each equipment WST, the lot swap time for each equipment LOH, and the exposure time for each equipment WET. In the production prediction model, time may be calculated in seconds.

$$WPD = 86400 \div ( WET + WST + LOH ) \qquad ( Equation 4 )$$

The processor 110 may evaluate the performance of the semiconductor exposure equipment based on the production prediction model. The processor 110 may determine the cause of loss of the equipment and an equipment solution corresponding to the cause of the loss based on the equipment performance evaluation results. For example, the processor 110 may execute the analysis application 220 stored in the memory 120 to evaluate the performance of semiconductor exposure equipment based on a production prediction model and identify causes and solutions for loss.

For example, the processor 110 may predict the daily wafer production for each equipment based on a production prediction model. The processor 110 may generate equipment statistical data about production for each equipment based on integrated data. For example, integrated data may include data on wafer production for each equipment. For example, the processor 110 may generate equipment statistical data on the production of each equipment based on data on the wafer production of each equipment up to the time of performance evaluation. For example, equipment statistical data may include an average value of daily wafer production for each equipment. The processor 110 may evaluate the performance of each equipment by comparing the predicted production based on equipment statistical data and the production prediction model. For example, the processor 110 may determine that the performance of the equipment has deteriorated when the daily wafer production predicted based on the production prediction model is less than the average value of the daily wafer production based on equipment statistical data. The processor 110 may determine that the performance of the equipment has been maintained or improved when the daily wafer production predicted based on the production prediction model is greater than or equal to the average daily wafer production based on equipment statistical data.

The processor 110 may perform performance evaluation on new equipment. For example, the processor 110 may compare the average value of daily wafer production of the same or similar equipment model as the evaluation target equipment with the daily wafer production of the evaluation target equipment predicted based on the production prediction model, and evaluate the performance of the evaluation target equipment. For example, if the daily wafer production of the new equipment predicted based on the production prediction model is less than the average value of the daily wafer production based on equipment statistical data for the existing equipment, the processor 110 may determine that the performance of the new equipment is lower than that of the existing equipment.

Hereinafter, operations performed by the processor 110 based on the determination that the performance of the equipment has deteriorated may be performed in the same or similar method even when the processor 110 determines that the performance of the new equipment is lower than the performance of the existing equipment.

The processor 110 may determine that the performance of the equipment has deteriorated through an evaluation based on a production prediction model, and identify a time that is greater than or equal to a specified value among the wafer swap time, lot swap time, and exposure time. The processor 110 may determine the cause of equipment loss based on wafer change time, lot change time, and/or exposure time being greater than or equal to a specified value. For example, the processor 110 may determine ‘increased wafer swap time’, ‘increased lot swap time’, and/or ‘increased exposure time’ as the primary cause of loss.

According to some example embodiments, integrated data may include error and event information of equipment and parameter values of equipment and products. The processor 110 may identify equipment error and event information, and parameter values of equipment and products from the integrated data. The processor 110 may determine the cause of equipment loss based on equipment error and event information and parameter values of equipment and products. Based on a predetermined algorithm, the processor 110 may determine the cause of loss corresponding to equipment error and event information and changes in parameter values of equipment and products.

For example, information matching codes representing errors and events and predetermined causes of loss related to each code may be stored in the memory 120. The processor 110 may determine the cause of loss based on matching information between the code and the cause of loss stored in the memory 120. For example, information matching changes in parameter values of equipment and products and predetermined causes of loss related to each change may be stored in the memory 120. Changes in parameter values may include the parameter value falling outside a specified range. The processor 110 may determine the cause of loss based on changes in parameter values stored in the memory 120 and matching information on the cause of loss.

For example, the processor 110 may determine the cause of secondary loss of equipment by identifying error and event information related to the primary cause of loss, and/or parameter values of equipment and products related to the primary cause of loss. Secondary causes of loss may be more specific than the primary cause of loss. For example, a secondary cause of loss may include the occurrence of an error or event related to the primary cause of loss, or a parameter value related to the primary cause of loss being outside a specified or alternatively, desired range, but example embodiments are not limited thereto. For example, the processor 110 may determine an error or event that occurred within a time interval determined to be the primary cause of loss, or a parameter value outside a specified or alternatively, desired range within the time interval determined to be the primary cause of loss, as the secondary cause of loss.

The processor 110 may obtain an equipment solution based on the cause of the loss. The processor 110 may determine an equipment solution corresponding to the cause of loss based on a predetermined or alternatively, desired algorithm. For example, information matching causes of loss and predetermined equipment solutions related to each cause of loss may be stored in the memory 120. The processor 110 may determine an equipment solution based on matching information of the cause of loss and equipment solution stored in the memory 120.

The processor 110 may store equipment performance evaluation results, cause of loss, and equipment solutions in the memory 120. For example, the processor 110 may store equipment performance evaluation results, cause of loss, and equipment solutions in the analysis database 121 of the memory 120.

The processor 110 may output equipment performance evaluation results, cause of loss, and equipment solutions to the display 140. For example, the processor 110 may execute the web application 230 stored in the memory 120 to visually provide equipment performance evaluation results, cause of loss, and equipment solutions to a user (e.g., engineer). For example, in some example embodiments, the processor 110 may be configured to execute the web application 230 stored in the memory 120 to visually send, transmit, provide, or display the equipment performance evaluation results, cause of loss, and equipment solutions to a user (e.g., an engineer) via the display 140.

The memory 120 may store data used by at least one component (e.g., the processor 110 or the communication circuit 130) of the electronic device 101. The memory 120 may store instructions executed by at least one processor 110. The memory 120 may store data transmitted or sent and received through the communication circuit 130. For example, the memory 120 may store equipment data received from the equipment database 103 through the communication circuit 130.

The memory 120 may include an analysis database 121. The analysis database 121 may store equipment data received through the communication circuit 130. The analysis database 121 may store integrated data generated by the integrated data generation module 111. The analysis database 121 may store the production prediction model generated by the prediction model generation module 112. The analysis database 121 may store equipment performance evaluation results evaluated based on the production prediction model. The analysis database 121 may store causes of loss and equipment solutions analyzed based on equipment performance evaluation results.

According to some example embodiments, the memory 120 may store API 210, analysis application 220, and web application 230. In some example embodiments, applications stored in the memory 120 may include, but are not limited to, the analysis application 220 and the web application 230. In some example embodiments, the memory 120 may further include various applications in addition to various analysis applications 220 and web applications 230.

The API 210 serves to connect applications so that the applications may use functions and/or data provided by other programs (e.g., other applications). For example, the API 210 may transmit or send a production prediction model to the analysis application 220. The analysis application 220 may evaluate the performance of the equipment based on the production prediction model transmitted through the API 210. The analysis application 220 may evaluate the performance of the equipment by comparing the predicted production based on the production prediction model with statistical data generated based on integrated data stored in the analysis database 121. The analysis application 220 may obtain cause of loss and equipment solutions based on performance evaluation results and integrated data.

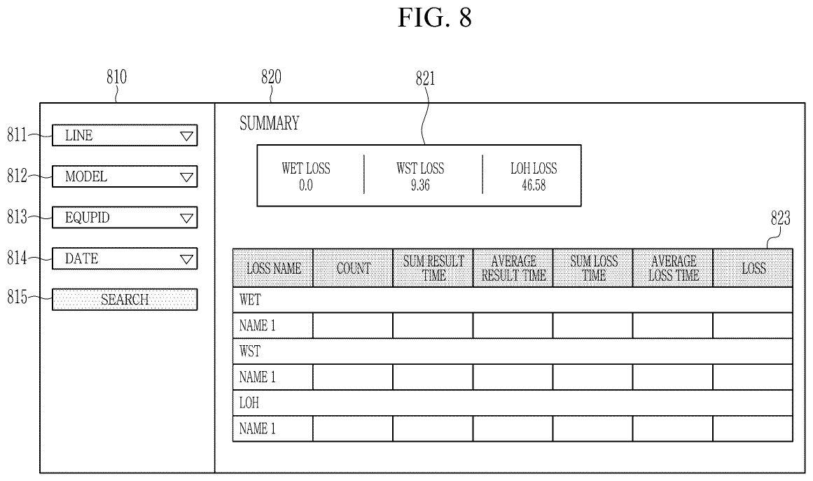

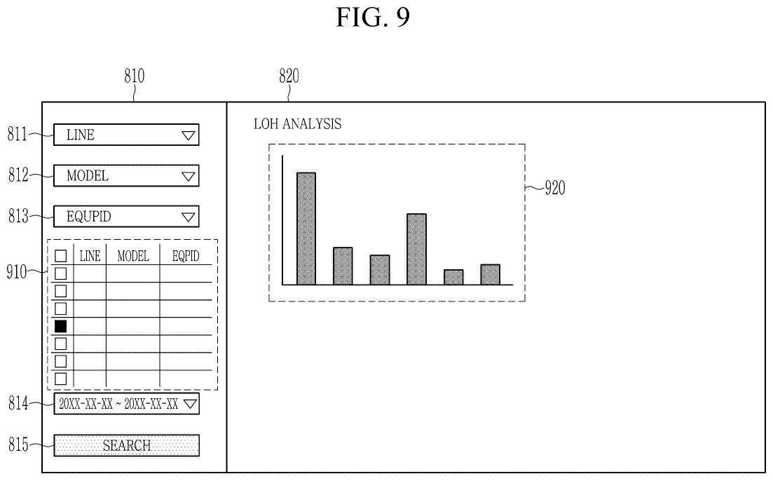

For example, the API 210 may transmit or send performance evaluation results, cause of loss, and equipment solutions obtained by the analysis application 220 to the web application 230. The web application 230 may generate visualization information related to equipment performance evaluation based on the performance evaluation results, cause of loss, and equipment solutions transmitted through the API 210. The web application 230 may output visualization information related to equipment performance evaluation to the display 140. Visualization information related to equipment performance evaluation, according to some example embodiments, will be described in more detail later with reference to FIGS. 8 and 9.

The communication circuit 130 may communicate with an external electronic device through a wired or wireless communication network. For example, the communication circuit 130 may perform a communication connection between the electronic device 101 and the equipment database 103. The equipment database 103 may store equipment data of semiconductor exposure equipment. Equipment data is stored in the form of a plurality of tables, but may be normalized and stored for each table.

The display 140 may visually provide various information to a user (e.g., engineer) of the electronic device 101. The display 140 may display data processed by the processor 110. For example, the display 140 may display content (e.g., text, images, video, icons, and/or symbols) that includes visual information related to equipment performance evaluation. Visualization information related to equipment performance evaluation may include performance evaluation results, cause of loss, and equipment solutions.

The display 140 may include, for example, a touch screen and may receive a touch, gesture, proximity, or hovering input using an electronic pen or a part of the user's body. In some example embodiments, the display 140 may also be used as an input device, but example embodiments are not limited thereto. In some example embodiments, the electronic device 101 may include a separate input device.

According to some example embodiments, the electronic device 101 may generate a production prediction model, evaluate the performance of equipment based on the production prediction model, and obtain the cause of loss and the corresponding equipment solution. In some example embodiments, some of the operations performed by the electronic device 101 may be executed by one or more electronic devices that communicate with the electronic device 101. For example, the operations of the analysis application 220 and the web application 230 may be executed by different electronic devices. For example, the electronic device 101 may transmit or send the production prediction model to a first external electronic device that stores the analysis application 220. The first external electronic device may execute the analysis application 220 to evaluate the performance of the semiconductor exposure equipment based on the production prediction model. The first external electronic device may analyze the evaluation results to obtain cause of loss and equipment solutions. The first external electronic device may transmit or send the performance evaluation result, the cause of loss, and the equipment solution corresponding to the cause of loss to the second external electronic device that stores the web application 230. The second external electronic device may execute the web application 230 to visualize and provide to a user (e.g., an engineer) the performance evaluation results, the cause of loss, and the equipment solution corresponding to the cause of loss. The second external electronic device may output, for example, a performance evaluation result, a cause of loss, and an equipment solution corresponding to the cause of loss through a display. In some example embodiments, the first external electronic device may transmit or send the performance evaluation result, the cause of loss, and the equipment solution corresponding to the cause of loss to the electronic device 101. The electronic device 101 may store performance evaluation results, the cause of loss, and equipment solutions corresponding to the cause of loss.

According to some example embodiments, the electronic device 101 may generate a model that predicts the production of the semiconductor exposure equipment based on the process time, evaluate the performance of the equipment based on the production prediction model, obtain the cause of loss and equipment solutions, and visualize and provide to a user (e.g., an engineer) the performance evaluation results, the cause of loss, and/or solutions. The electronic device 101 may provide performance evaluation results, the cause of loss, and/or solutions by automating the above-described performance evaluation, cause analysis, and solution derivation processes without the intervention of an engineer. For example, if the production of a semiconductor exposure equipment decreases, an engineer may need to manually check equipment logs to identify increased process times, analyze losses, and derive solutions. However, according to some example embodiments, an engineer may improve the semiconductor exposure equipment based on information provided by the electronic device 101, thereby improving the productivity of the semiconductor exposure equipment while minimizing the engineer's time and effort.

According to some example embodiments, the electronic device 101 may accumulate equipment performance evaluation results generated based on equipment data and a production prediction model based on process time, and the resulting cause of loss and equipment solutions in a database. The electronic device 101 may accelerate the stabilization of production of new equipment by utilizing initial equipment evaluation and operation based on the accumulated data when introducing new equipment.

According to some example embodiments, the electronic device 101 may obtain optimal equipment parameters by using a production prediction model as a production simulator according to equipment parameters.

According to some example embodiments, the electronic device 101 may generate a production prediction model based on the first quartile for each equipment model with respect to wafer swap time and lot swap time, and may evaluate performance and improve loss based the production prediction model. Accordingly, the performance of each equipment model may be standardized upward.

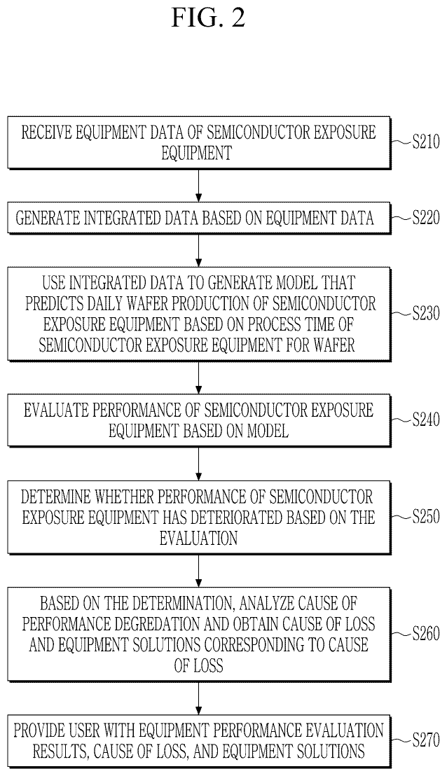

Hereinafter, the operation method of the electronic device according to some example embodiments will be described with reference to FIGS. 2 to 7.

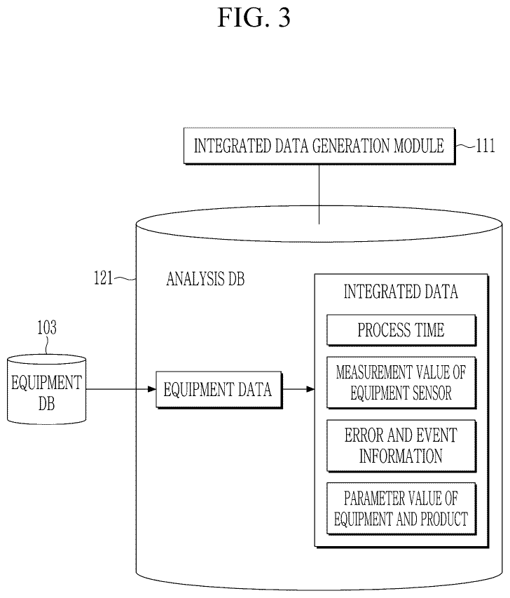

FIG. 2 is a flowchart showing an operation method of an electronic device according to some example embodiments. FIGS. 3 to 7 are drawings for describing operations of an electronic device according to some example embodiments. Operations of the electronic device described later may be performed by the electronic device 101 of FIG. 1.

Referring to FIG. 2, in operation S210, the electronic device may receive equipment data of the semiconductor exposure equipment. The electronic device may receive equipment data of the semiconductor exposure equipment from an external database through a communication circuit (e.g., 130 in FIG. 1). The electronic device may store the received equipment data in a memory (e.g., 120 in FIG. 1).

For example, a semiconductor exposure equipment may be an EUV equipment. An exposure process using a semiconductor exposure equipment may include exposure time (WET), wafer swap time (WST), and lot swap time (LOH).

Equipment data of semiconductor exposure equipment may include, for example, track process history, equipment operation history, wafer production history, lot production history, layout history, wafer reject history, performance history, equipment error history, equipment event history, and/or equipment sensor history, but example embodiments are not limited thereto.

In operation S220, the electronic device may generate integrated data based on equipment data. The electronic device may generate integrated data that integrates equipment data by wafer and equipment model.

Referring to FIG. 3, the electronic device may receive equipment data from the equipment database (equipment DB) 103 and store the equipment data in the analysis database (analysis DB) 121. Equipment data may be stored in the equipment DB 103 in the form of a plurality of tables and may be normalized for each table. The electronic device may denormalize equipment data received from the equipment DB 103 and store it in the analysis DB 121. The electronic device may integrate data distributed in each table of the equipment DB 103 and store it in the analysis DB 121.

The integrated data generation module 111 of the electronic device may generate integrated data based on equipment data stored in the analysis DB 121. The integrated data generation module 111 may integrate process time among equipment data for each wafer and equipment model. Process time may include, for example, wafer swap time (WST), lot swap time (LOH), and exposure time (WET). The integrated data generation module 111 may integrate measurement values from equipment sensors among equipment data for each wafer and equipment model. The measurement value of the equipment sensor may include measurement values of a plurality of sensors in the equipment. The integrated data generation module 111 may integrate equipment error and event information among equipment data for each wafer and equipment model. Error and event information may include code information for a designated code depending on the error and event type. The integrated data generation module 111 may integrate equipment and product parameter values among the equipment data for each wafer and equipment model. Parameter values of equipment and products may include product specification information, process recipe information, and/or equipment setting values.

Integrated data may include process time, measurement values of equipment sensors, equipment error and event information, and parameter values of equipment and products. The electronic device may store integrated data in the analysis DB 121.

Referring again to FIG. 2, in operation S230, the electronic device may use the integrated data to generate a model that predicts the daily wafer production of the semiconductor exposure equipment based on the process time of the semiconductor exposure equipment for the wafer. The electronic device may preprocess the integrated data and obtain wafer data, lot data, and parameter data from the preprocessed integrated data. The electronic device may generate a model that predicts the daily wafer production (wafer per day, WPD) based on wafer data, lot data, and parameter data.

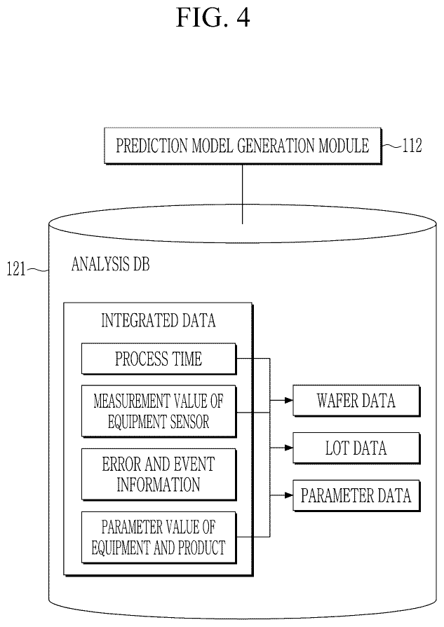

Referring to FIG. 4, the prediction model generation module 112 of the electronic device may preprocess integrated data stored in the analysis DB 121. For example, the prediction model generation module 112 may remove invalid data such as reject wafers or non-pattern wafers from the integrated data.

The prediction model generation module 112 may obtain wafer data, lot data, and parameter data based on the process time of the preprocessed integrated data, measurement values of equipment sensors, and/or parameter values of equipment and products. The prediction model generation module 112 may obtain wafer data by sorting data related to the wafer according to exposure time. Data related to the wafer may include, for example, wafer swap time, exposure time, and product parameter values. The prediction model generation module 112 may obtain lot data by sorting the data related to lot according to the time the wafer was input into the equipment. Data related to lot may include, for example, lot swap times. The prediction model generation module 112 may obtain parameter data by arranging the parameter values of equipment and products and the measurement values of equipment sensors according to the sensor measurement time. Parameter data may be data that links parameter values of equipment and products with measurement values of equipment sensors.

For example, the prediction model generation module 112 may not use equipment error and event information.

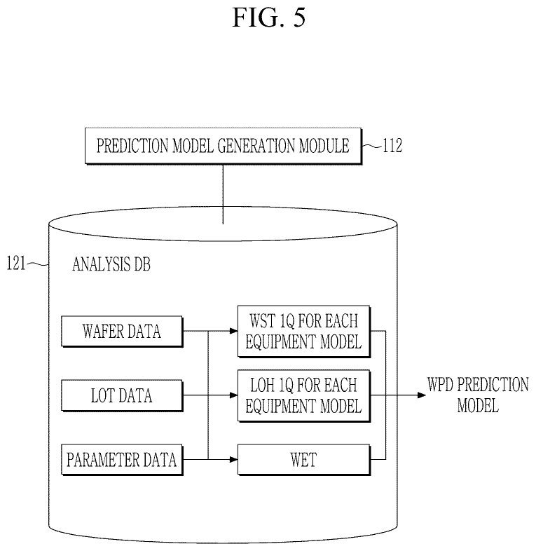

Referring to FIG. 5, the prediction model generation module 112 may calculate a first quartile 1Q of wafer swap time (WST) for each equipment model based on wafer data. Wafer data may include wafer swap time data for each equipment model. The prediction model generation module 112 may sort the wafer swap time data for each equipment model from small to large values and then calculate a value corresponding to the top 25%.

The prediction model generation module 112 may calculate the first quartile 1Q of lot swap time (LOH) for each equipment model based on lot data. Lot data may include lot swap time data for each equipment model. The prediction model generation module 112 may sort the lot swap time data for each equipment model from small to large values and then calculate a value corresponding to the top 25%.

The prediction model creation module 112 may identify the models of each equipment, and may obtain the first quartile of the wafer swap time and the first quartile of the lot swap time for the identified equipment model as the wafer swap time and lot swap time for one wafer of each equipment.

The prediction model generation module 112 may calculate the average exposure time (WET) for each equipment based on wafer data and parameter data. The prediction model generation module 112 may filter abnormal data related to overlapping exposure from wafer data. For example, the prediction model generation module 112 may calculate the scan time, which is a variable proportional to the exposure time, calculate the ratio of the scan time to the exposure time for each wafer, and remove data where the calculated ratio forms an abnormal cluster.

The prediction model generation module 112 may learn the correlation between exposure time and parameter values of equipment and products using the filtered wafer data and parameter data corresponding to the filtered wafer data. The prediction model generation module 112 may establish a relationship equation between the exposure time and parameter values of equipment and products, and may train the relationship equation using the filtered wafer data and corresponding parameter data as learning data. The prediction model generation module 112 may obtain the coefficient of the relationship equation between the exposure time and parameter values of equipment and products through learning. The prediction model generation module 112 may obtain a relationship equation between the exposure time and parameter values of equipment and products based on the obtained coefficients. The prediction model generation module 112 may calculate the exposure time for each process recipe for each equipment based on the obtained relationship equation.

The prediction model generation module 112 may calculate the exposure time for each equipment based on the ratio between at least one process recipe processed by each equipment. The prediction model generation module 112 may calculate the exposure time for each equipment by adding the exposure time for each process recipe of each equipment multiplied by the ratio of each process recipe. The calculated exposure time for each equipment may be the average exposure time for one wafer of each equipment.

The prediction model generation module 112 may generate the daily wafer production (WPD) prediction model based on wafer swap time for each equipment, lot swap time for each equipment, and exposure time for each equipment. For example, the prediction model generation module 112 may predict the daily wafer production of each equipment by dividing the time corresponding a day by the sum of the wafer swap time, lot swap time, and exposure time of each equipment.

Although not shown, in some example embodiments, the prediction model generation module 112 may check the validity of the WPD prediction model. The prediction model generation module 112 may evaluate the performance of the WPD prediction model. For example, if trends in facilities and production change or the performance of the WPD prediction model deteriorates, the prediction model generation module 112 may update the WPD prediction model based on data accumulated after the time of generation or previous update. For example, the prediction model generation module 112 may recalculate the coefficients of the relationship equation between the exposure time and parameter values of equipment and products based on the accumulated data, and update the WPD prediction model based on the recalculated coefficients.

Referring again to FIG. 2, in operation S240, the electronic device may evaluate the performance of the semiconductor exposure equipment based on the model. The electronic device may evaluate the performance of the semiconductor exposure equipment by comparing the daily wafer production predicted based on the model with statistical data on the daily wafer production. If it is determined that the performance of the semiconductor exposure equipment has deteriorated, the electronic device may analyze the cause of the performance degradation, and obtain the cause of loss and equipment solutions that correspond to the cause of loss. The electronic device may visualize and provide the user with equipment performance evaluation results, the cause of loss, and equipment solutions. For example, in operation S250, the electronic device may determine whether the performance of the semiconductor exposure equipment has deteriorated based on the evaluation of operation S240. In operation S260, if the semiconductor device determines that the performance of the semiconductor exposure equipment has deteriorated, the electronic device may analyze the cause of the performance degradation, and obtain the cause of loss and equipment solutions that correspond to the cause of loss. In some example embodiments, in operation S270, the electronic device may visualize and provide a user with the equipment performance evaluation results, the cause of loss, and the equipment solutions.

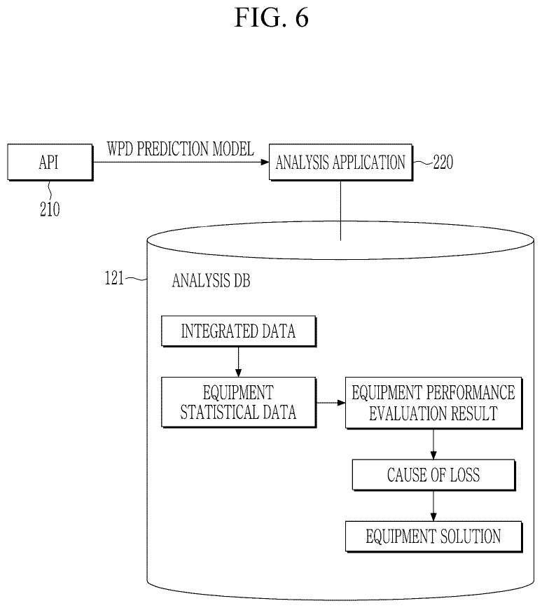

Referring to FIG. 6, the API 210 of the electronic device may transmit or send the WPD prediction model to the analysis application 220. The analysis application 220 of the electronic device may generate equipment statistical data based on integrated data stored in the analysis DB 121. The analysis application 220 may generate equipment statistical data by calculating the average value of daily wafer production for each equipment based on the wafer production history of each equipment among the integrated data. The analysis application 220 may evaluate the performance of each equipment by comparing the daily wafer production of each equipment predicted based on the WPD prediction model with the average value of the daily wafer production of each equipment according to equipment statistical data. The analysis application 220 may determine that the performance of the equipment has deteriorated when the predicted daily wafer production is less than the average value of daily wafer production according to statistics. The analysis application 220 may obtain equipment performance evaluation results, including whether the performance of equipment has deteriorated.

The analysis application 220 may also perform performance evaluation on new equipment. The analysis application 220 may compare the daily wafer production of the new equipment predicted based on the WPD prediction model with the average value of the daily wafer production of equipment of the same or similar model as the new equipment according to equipment statistical data to evaluate the performance of the new equipment.

In some example embodiments, if it is determined that the performance of the equipment has deteriorated, the analysis application 220 may identify the process time that causes the performance deterioration. The analysis application 220 may identify a time that is greater than or equal to a specified value among wafer swap time (WST), lot swap time (LOH), and exposure time (WET). The analysis application 220 may determine the cause of loss based on the identified process time. For example, the analysis application 220 may determine ‘increased wafer swap time (WST)’, ‘increased lot change time (LOH)’, and/or ‘increased exposure time (WET)’ as the primary cause of loss.

The analysis application 220 may determine the cause of loss of the equipment based on equipment error and event information and equipment and product parameter information among the integrated data. Based on a predetermined or alternatively, desired algorithm, the analysis application 220 may determine the cause of loss corresponding to equipment error and event information and changes in parameter values of equipment and products. The analysis application 220 may determine the cause of loss based on the matching information of the code representing errors and events, predetermined cause of loss related to the code, and/or the change in parameter values by parameter and the matching information of predetermined cause of loss related to the change in parameter values. The analysis application 220 may identify error and event information and parameter information of equipment and products related to the primary cause of loss, and determine the cause of loss corresponding to the identified information as the secondary cause of loss.

The analysis application 220 may obtain an equipment solution based on the cause of the loss. The analysis application 220 may determine an equipment solution corresponding to the cause of loss based on a predetermined or alternatively, desired algorithm. The analysis application 220 may determine an equipment solution based on matching information of the causes of loss and predetermined equipment solutions related to each cause of loss.

For example, if the primary cause of loss is ‘increased lot swap time (LOH)’, the analysis application 220 may identify that a large amount of dummy chuck swap events occurred within the time interval corresponding to the increased lot swap time (LOH). The analysis application 220 may determine ‘a large number of dummy chuck swap events’ as the secondary cause of loss. If the cause of loss is ‘a large number of dummy chuck swap events’, the analysis application 220 may determine ‘improvement of the dummy chuck swap scheduler’ as an equipment solution.

The analysis application 220 may store equipment performance evaluation results, the cause of loss, and equipment solutions in the analysis DB 121. Although not shown, in some example embodiments, the analysis application 220 may perform an initial performance evaluation of new equipment based on the equipment performance evaluation results, the cause of loss, and equipment solutions stored in the analysis DB 121, identifies the cause of loss early, and obtain equipment solutions early. Based on the obtained equipment solutions, stabilization of production of new equipment may be accelerated.

Although not shown, in some example embodiments, the analysis application 220 may obtain optimal equipment parameters by using the WPD prediction model as a production simulator according to equipment parameters. By applying the obtained optimal equipment parameters to the equipment, the productivity of the equipment may be maximized.

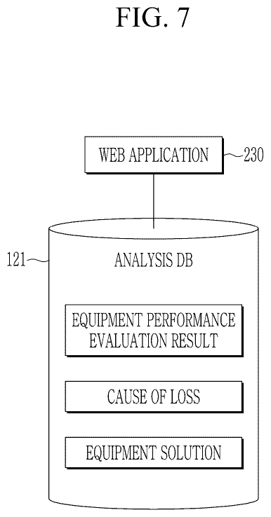

Referring to FIG. 7, the web application 230 of the electronic device may visualize and provide the user with the equipment performance evaluation results, cause of loss, and equipment solutions stored in the analysis DB 121. The web application 230 may output visualization information of equipment performance evaluation results, cause of loss, and equipment solutions to a display (e.g., 140 in FIG. 1).

Hereinafter, with reference to FIGS. 8 and 9, visualization information provided by an electronic device according to some example embodiments will be described.

FIGS. 8 and 9 are diagrams illustrating examples of visualization information provided by an electronic device according to some example embodiments. Operations of the electronic device described later may be performed by the electronic device 101 of FIG. 1. For example, the electronic device may provide visualization information through a web application (e.g., 230 in FIGS. 1 and 7). For example, the electronic device may display the visualization information shown in FIGS. 8 and 9 on a display (e.g., 140 in FIG. 1).

Referring to FIGS. 8 and 9, visualization information provided by an electronic device may be a graphic user interface (GUI). Referring to FIG. 8, a first region 810 of the GUI may provide a first drop-down menu 811 including an equipment line list, a second drop-down menu 812 including an equipment model list, a third drop-down menu 813 including an equipment ID list, a fourth drop-down menu 814 including a date list, and a search button 815 to which a search operation is mapped. The electronic device may receive a user input for selecting an equipment line through the first drop-down menu 811. The electronic device may receive a user input for selecting an equipment model through the second drop-down menu 812. The electronic device may receive a user input for selecting an equipment ID through the third drop-down menu 813. The electronic device may receive a user input for selecting a date or period through the fourth drop-down menu 814.

The search button 815 to which an operation for searching equipment performance evaluation results is mapped may be provided in the first region 810 of the GUI. Based on the user input of selecting the search button 815, the electronic device may search for equipment performance evaluation results conditioned on the items selected through the first drop-down menu 811, the second drop-down menu 812, the third drop-down menu 813, and the fourth drop-down menu 814.

The electronic device may display the searched equipment performance evaluation results in the second region 820 of the GUI.

Loss summary information by process time 821 may be provided in the second region 820 of the GUI. The loss summary information by process time 821 may include the number loss of daily wafer production caused by exposure time WET, wafer swap time WST, and lot swap time LOH. The electronic device may provide the user with the loss of daily wafer production corresponding to the equipment line, equipment model, equipment ID, and period selected based on the user input through the loss summary information by process time 821.

Loss detailed information by process time 823 may be provided in the second region 820 of the GUI. The loss detailed information by process time 823 may include detailed information on at least one loss. The loss detailed information by process time 823 may be provided, for example, in a table form. At least one loss may be classified and displayed as a loss due to an increase in exposure time (WET), a loss due to an increase in wafer swap time (WST), and a loss due to an increase in lot swap time (LOH).

The loss detailed information by process time 823 may include, for example, loss name, loss count, sum result time, average result time, sum loss time, average loss time, and the number of loss. The loss name may represent the type of loss. The loss count may represent the number of times a loss occurred. The sum result time may represent the total process time that affected the loss for the wafer in which the loss occurred. The average result time may represent the average of the process time that affected the loss for the wafer in which the loss occurred. The sum loss time may represent the total loss of process time for wafers in which loss occurred. The average loss time may represent the loss average of the process time for the wafer in which loss occurred. The number of loss may represent the number of wafers in which a loss occurred.

The electronic device may receive a user input for selecting an item displaying the process time displayed in the loss summary information by process time 821 or the loss detailed information by process time 823. For example, the electronic device may display the GUI of FIG. 9 based on a user input of selecting an item displaying lot swap time (LOH). Referring to FIG. 9, a list 910 of losses occurring due to an increase in lot swap time (LOH) may be provided in the first region 810 of the GUI. The list 910 may include information about the equipment line in which the loss occurred, equipment model, and equipment ID. In some example embodiments, the date or period on which the loss occurred may be displayed through the fourth drop-down menu 814 of the GUI of FIG. 9.

The list 910 may include check boxes corresponding to each item. The electronic device may filter information to be displayed in the second region 820 based on a user input of selecting a checkbox. In the second region 820 of the GUI, analysis information 920 on loss corresponding to an item selected through a check box in the list 910 may be provided. For example, the analysis information 920 may be analysis information about losses caused by an increase in lot swap time (LOH). The analysis information 920 may be provided, for example, in the form of a graph.

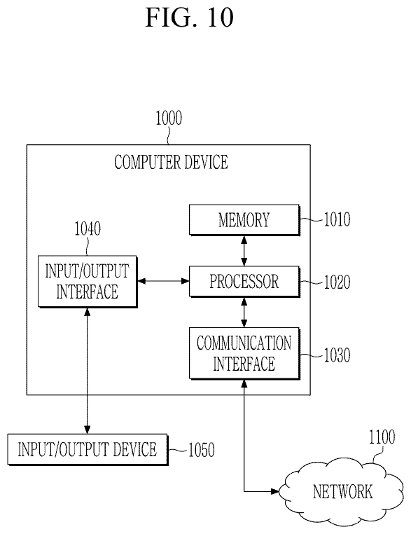

FIG. 10 is a diagram illustrating an example of a computer device implementing an electronic device according to some example embodiments. The electronic device 101 of FIG. 1 may be implemented by the computer device 1000 shown in FIG. 10.

Referring to FIG. 10, the computer device 1000 may include a memory 1010, a processor 1020, a communication interface 1030, and an input/output interface 1040.

The memory 1010 may include a permanent mass storage device, such as random-access memory (RAM), a read only memory (ROM), and a disk drive, as a computer-readable storage medium. In some example embodiments, an operating system and at least one program code may be stored in the memory 1010. Such software components may be loaded into the memory 1010 from a computer-readable recording medium separate from the memory 1010. The other computer-readable storage medium may include computer-readable storage medium, such as a hard disk, a flash memory, an optical disk, and an external hard disk. In some example embodiments, such software components may be loaded into the memory 1010 through the communication interface 1030.

The processor 1020 may be configured to process instructions of a computer program by performing basic arithmetic, logic, and input/output operations. Instructions may be provided to the processor 1020 by the memory 1010 or the communication interface 1030.

The communication interface 1030 may provide a function for the computer device 1000 to communicate with other devices through the network 1100. The communication method is not limited, and may include not only a communication method utilizing a communication network that the network 1100 may include (e.g., a mobile communication network, wired Internet, wireless Internet, or a broadcast network), but also short-range wireless communication between devices. For example, the network 1100 may include any one or more networks, such as a personal area network (PAN), a local area network (LAN), a campus area network (CAN), a metropolitan area network (MAN), a wide area network (WAN), a broadband network (BBN), and the internet. In some example embodiments, the network 1100 may include any one or more of network topologies including a bus network, star network, ring network, mesh network, star-bus network, tri or hierarchical network, or the like, but example embodiments are not limited thereto.

The input/output interface 1040 may serve as an interface that can transmit instructions or data input from the user or the input/output device 1050 to other component(s) of the computer device 1000. In some example embodiments, the input/output interface 1040 may output instructions or data received from other component(s) of the computer device 1000 to the user or the input/output device 1050. For example, the input/output device 1050 may include an input device such as a microphone, keyboard, or mouse, and the output device may include an output device such as a display or speaker.

The example embodiments described above may be implemented in the form of a computer program that can be executed through various components on a computer, and such a program may be stored on a computer-readable medium. For example, the medium may include magnetic medium such as hard disks, floppy disks, and magnetic tapes, optical recording medium such as CD-ROMs and DVDs, magneto-optical medium such as floptical disks, and hardware devices specifically configured to store and execute program instructions, such as ROM, RAM, flash memory, or the like.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a non-transitory computer readable medium and may store a program of instructions. Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Further, any learning, learning models, machine learning models, or elements described herein, may, for example, use various artificial neural network organizations and processing models, the artificial neural network organizations including, for example, a convolutional neural network (CNN), a deconvolutional neural network, a recurrent neural network optionally including a long short-term memory (LSTM) and/or a gated recurrent unit (GRU), a stacked neural network (SNN), a state-space dynamic neural network (SSDNN), a deep belief network (DBN), a generative adversarial network (GAN), and/or a restricted Boltzmann machine (RBM), and/or the like; and/or include linear and/or logistic regression, statistical clustering, Bayesian classification, decision trees, and/or the like.

The steps and/or operations of all methods described herein can be performed in any suitable order unless otherwise indicated herein or otherwise clearly contradicted by context. The present inventive concepts are not necessarily limited to the described order of the above steps and/or operations.

The use of any and all examples, or exemplary language provided herein, is intended merely to better illuminate some exemplary embodiments and does not pose a limitation on the scope of the exemplary embodiments. Numerous modifications and adaptations will be readily apparent to one of ordinary skill in the art without departing from the spirit and scope of the exemplary embodiments.

While example embodiments of the present inventive concepts have been described in detail, it is to be understood that the present inventive concepts are not limited to the disclosed example embodiments, but on the contrary, are intended to cover various modifications and equivalent arrangements included within the spirit and scope of the appended claims.

What is claimed is:

1. An electronic device, comprising:
a communication circuit;
at least one processor; and
at least one memory configured to store instructions, the at least one memory and instructions configured to, with the at least one processor, cause the electronic device to:
receive equipment data of a semiconductor exposure equipment from an external database through the communication circuit,
generate integrated data that integrates the equipment data by wafer and equipment model,
generate a model that predicts daily wafer production of the semiconductor exposure equipment based on process time of the semiconductor exposure equipment for a wafer using the integrated data, the process time including wafer swap time for each equipment, lot swap time for each equipment, and exposure time for each equipment, and
evaluate performance of the semiconductor exposure equipment based on the generated model.

2. The electronic device of claim 1, wherein the electronic device is further configured to:
generate the integrated data by integrating the process time, measurement value of equipment sensor, error and event information of equipment, and parameter value of the equipment and product among the equipment data for each wafer and equipment model.

3. The electronic device of claim 1, wherein the electronic device is further configured to:
remove invalid data of the integrated data,
obtain wafer data by sorting wafer-related data of the integrated data according to exposure time,
obtain lot data by sorting lot-related data of the integrated data according to time the wafer was input into the equipment, and
obtain parameter data by sorting parameter value of equipment and product of the integrated data and measured value of equipment sensor according to sensor measurement time.

4. The electronic device of claim 3, wherein the electronic device is further configured to:
calculate a first quartile of wafer swap time for each equipment model based on the wafer data, and
calculate the first quartile of lot swap time for each equipment model based on the lot data.

5. The electronic device of claim 3, wherein the electronic device is further configured to:
perform filtering on overlapping exposure on the wafer data,
learn a correlation between exposure time and equipment and product parameter using the filtered wafer data and the parameter data, and
calculate the exposure time for each equipment based on the learned correlation.

6. The electronic device of claim 5, wherein the electronic device is further configured to:
calculate exposure time for each process recipe of each equipment based on the learned correlation, and
calculate the exposure time for each equipment based on a ratio between at least one process recipe processed by each equipment.

7. The electronic device of claim 1, wherein the wafer swap time for each equipment, the lot swap time for each equipment, and the exposure time for each equipment are times for one wafer, and
the model is obtained by dividing time corresponding to a day by a sum of the wafer swap time for each equipment, the lot swap time for each equipment, and the exposure time for each equipment.

8. The electronic device of claim 1, wherein the electronic device is further configured to:
predict the daily wafer production for each equipment based on the model,
generate equipment statistical data on production for each equipment based on the integrated data, and
evaluate the performance for each equipment based on the equipment statistical data and the predicted production.

9. The electronic device of claim 8, wherein the electronic device is further configured to:
based on a determination that the performance of the equipment has deteriorated through the evaluation,
identify a time value that is greater than or equal to a time value among the wafer swap time, the lot swap time, and the exposure time, and
determine a cause of loss of the equipment based on the identified time value.

10. The electronic device of claim 9, wherein the electronic device is further configured to:
identify error and event information of the equipment and parameter values of the equipment and product from the integrated data, and
determine the cause of loss of the equipment based on the identified information.

11. The electronic device of claim 9, further comprising a display, and
wherein the electronic device is further configured to:
output an equipment performance evaluation result obtained based on the evaluation and the cause of loss, and an equipment solution corresponding to the cause of loss on the display.

12. An electronic device, comprising:
a communication circuit;
at least one processor; and
at least one memory configured to store instructions, the at least one memory and instructions configured to, with the at least one processor, cause the electronic device to:
receive equipment data of a semiconductor exposure equipment from an external database through the communication circuit,
generate integrated data that integrates the equipment data by wafer and equipment model,
preprocess the integrated data to obtain wafer data, lot data, and parameter data,
calculate wafer swap time for each equipment, lot swap time for each equipment, and exposure time for each equipment based on the wafer data, the lot data, and the parameter data,
generate a production prediction model that predicts daily wafer production based on the wafer swap time for each equipment, the lot swap time for each equipment, and the exposure time for each equipment, and
evaluate performance of the semiconductor exposure equipment based on the production prediction model.

13. The electronic device of claim 12, wherein the electronic device is further configured to:
generate the integrated data by integrating process time, measurement value of equipment sensor, error and event information of equipment, and parameter value of the equipment and product among the equipment data for each wafer and equipment model.

14. The electronic device of claim 12, wherein the electronic device is further configured to:
remove invalid data of the integrated data,
obtain the wafer data by sorting wafer-related data of the integrated data according to exposure time,
obtain the lot data by sorting lot-related data of the integrated data according to a time the wafer was input into the equipment, and
obtain the parameter data by sorting parameter value of the equipment and product of the integrated data and measured value of equipment sensor according to sensor measurement time.

15. The electronic device of claim 14, wherein the electronic device is further configured to:
calculate wafer swap time for each equipment model based on the wafer data,
calculate lot swap time for each equipment model based on the lot data, and
calculate the exposure time for each equipment based on the wafer data and the parameter data.

16. The electronic device of claim 15, wherein the electronic device is further configured to:
generate the production prediction model based on the exposure time for each equipment calculated based on a first quartile of the wafer swap time for each equipment model, the first quartile of lot swap time for each equipment model, and a learned correlation between exposure time and equipment and product parameter.

17. The electronic device of claim 16, wherein the production prediction model is obtained by dividing time corresponding to a day by a sum of the first quartile of the wafer swap time for each equipment model, the first quartile of lot swap time for each equipment model, and the exposure time for each equipment.

18. The electronic device of claim 12, wherein the electronic device is further configured to:
predict the daily wafer production for each equipment based on the production prediction model,
generate equipment statistical data on production for each equipment based on the integrated data, and
evaluate the performance for each equipment based on the equipment statistical data and the predicted production.

19. The electronic device of claim 18, wherein the electronic device is further configured to:
based on a determination that the performance of the equipment has deteriorated through the evaluation,
identify a time value that is greater than or equal to a time value among the wafer swap time, the lot swap time, and the exposure time, and
determine a cause of loss of the equipment based on the identified time value.

20. The electronic device of claim 19, further comprising a display, and
wherein the electronic device is further configured to:
display an equipment performance evaluation result obtained based on the evaluation, and the cause of loss and an equipment solution corresponding to the cause of loss on the display.
